(19) United States
(12) Patent Application Publication
(10) Pub. No.: US 2021/0097244 A1
(43) Pub. Date: Apr. 1, 2021

(54) APPARATUS, SYSTEM AND METHOD FOR PROVIDING DYNAMIC RFID IN A RETAIL ENVIRONMENT

(71) Applicants: Tony D'Onofrio, Alpharetta, GA (US); Ned McCauley, Alpharetta, GA (US)

(72) Inventors: Tony D'Onofrio, Alpharetta, GA (US); Ned McCauley, Alpharetta, GA (US)

(21) Appl. No.: 16/994,337

(22) Filed: Aug. 14, 2020

Related U.S. Application Data
(60) Provisional application No. 62/886,696, filed on Aug. 14, 2019.

(51) Int. Cl. G06K 7/10; G06N 20/00

(52) U.S. Cl. CPC G06K 7/10475; G06N 20/00

(57) ABSTRACT

An apparatus, system and method for providing an after-market dynamic RFID reader network in a niche environment. The apparatus, system and method include: a plurality of RF transceivers located around the niche environment so as to saturate the niche environment with radio frequencies capable of ringing RFID tags brought within the niche environment; an on-site controller capable of initially mapping a pattern provided by all of the plurality of RF transceivers in the niche environment; a testing tag suitable to be moved through the mapped pattern, wherein the on-site controller tracks the ringing of the testing tag as it moves through the mapped pattern; and an electronic tuner communicatively associated with the on-site controller, the electronic tuner being capable of tuning for the plurality of RF transceivers such that the RF transceivers indicate to the on-site controller a receipt of the ringing from the testing tag at all predetermined points in the mapped pattern.

### CROSS-REFERENCE TO RELATED APPLICATIONS

This application claims priority to U.S. Provisional Application Ser. No. 62/886,696, filed Aug. 14, 2019, entitled Apparatus, System and Method for Providing Dynamic RFID in a Retail Environment.

### BACKGROUND

### Field of the Disclosure

The disclosure relates to the control and monitoring of electronic devices, and, more specifically, to an apparatus, system and method for providing dynamic RFID in a retail environment.

### Description of the Background

It is presently well-known to provide Radio Frequency Identification (RFID) readers and antennas in a variety of different embodiments, such as for security and loss-prevention at the exit of retail establishments, along airport luggage conveyer systems, and the like. RFID systems employ digital data encoded into RFID tags or smart labels (such as clothing tags or luggage tags). This digital data is then captured by a reader that uses radio waves to “ring” the tag, at which time the reader “reads” the digital data provided responsive to the ringing. Typically, the data captured from the tag or label is then stored in or compared by a database to some secondary information, such as a list of identifications of products that have been purchased at a retail establishment. An RFID tag may be read outside the line-of-sight, but must nevertheless be sufficiently proximate to the radio frequency ringing that actuates the tag.

RFID is an Automatic Identification and Data Capture (AIDC) technology. AIDC methods identify objects, collect data about them, and enter those data directly for manipulation/use into a computer system. RFID accomplishes the foregoing using three main components: a RFID tag; a RFID reader; and an antenna. More specifically, the RFID tag may contain an integrated circuit and an antenna, which transmits data to the RFID reader when the reader interrogates the tag via ringing it. Information collected from the tag is then transferred from the reader through a communications interface to a host computer system.

Thus, each environment in which an embodiment of a RFID system operates must include readers and tags, connected to a computing system. It is presently the case in all such embodiments that the setup of such tag/antenna and reader systems is done on site via a site survey performed by a team of setup professionals. That is, an on-site crew must tune the reader and tag/antenna system to each unique aspect of the environment into which the system is to operate.

Consequently, in many instances, such as for small retail establishments unable to afford professional setup the costs for RFID systems, RFID systems cannot be used due to prohibitive costs. Further, for “niche” security and loss prevention purposes, such as enhanced retail product loss prevention in dynamic inventory tracking environments, such as fitting rooms or behind large clothing racks, a reader and antenna system is not readily modifiable after its original professional design and setup, at least not without rehiring a professional setup crew to perform the modifications.

Thus, an improved solution over the currently available expensive hardware solutions, which are provided from pre-integrated RFID system providers who must tune the system on site upon installation, is needed.

### SUMMARY

An apparatus, system and method is disclosed for providing an after-market dynamic RFID reader network in a niche environment. The apparatus, system and method include: a plurality of RF transceivers located around the niche environment so as to saturate the niche environment with radio frequencies capable of ringing RFID tags brought within the niche environment; an on-site controller capable of initially mapping a pattern provided by all of the plurality of RF transceivers in the niche environment; a testing tag suitable to be moved through the mapped pattern, wherein the on-site controller tracks the ringing of the testing tag as it moves through the mapped pattern; and an electronic tuner communicatively associated with the on-site controller, the electronic tuner being capable of tuning for the plurality of RF transceivers such that the RF transceivers indicate to the on-site controller a receipt of the ringing from the testing tag at all predetermined points in the mapped pattern.

Therefore, the embodiments provide an improved solution over the currently available expensive RFID hardware solutions.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 is an illustration of aspects of the embodiments; and

FIG. 2 illustrates aspects of the embodiments.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments.

Processor-implemented modules, systems and methods of use may be disclosed herein that may provide access to and transformation of a plurality of types of digital content, including but not limited to video, image, text, audio, metadata, algorithms, identifiers, interactive and document content, and which track, deliver, manipulate, transform, transceive and report the accessed content. Described embodiments of these modules, systems and methods processed by processing system 30 are intended to be exemplary and not limiting.

The embodiments provide a solution that may self-modify and/or self-educate over time to better fit niche environments for RFID systems, such as in a retail environment, and which does not require professional on-site setup of a reader and tag/antenna system. Accordingly, unique on-site aspects, such as retail walking paths, clothing racks, baggage reading equipment positions along a conveyer, and the like, do not present issues to the disclosed systems and methods, as they do in the prior art.

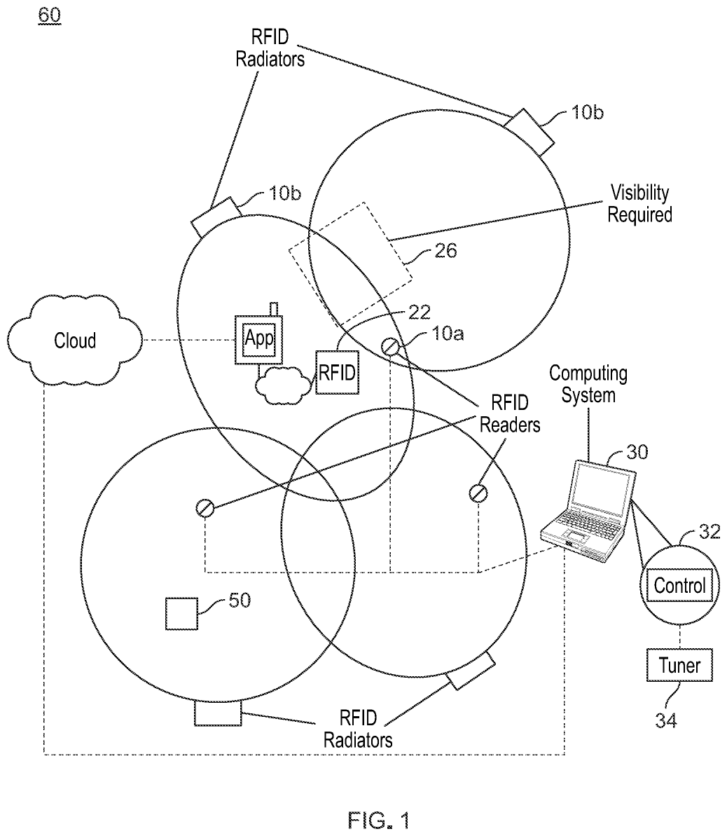

More particularly, the embodiments may employ simple broad radiators/transceivers, such as RF radiators/transceivers 10a/b, to saturate an area 60 with RF in order to ring local RFID tags 50 within the saturation region 60. As illustrated in FIG. 1, an on-site controller 32 or multiple on-site controllers may read the pattern provided by all radiators in an environment, and may “learn” a map of the solution area therefrom. Thereafter, one or more RFID tags 50 may be moved through the saturation field(s), as it/they may have been mapped, and may be tracked.

The controller 32 may learn from the response signal provided by an RFID test tag 22 to a reader or series of readers 10 what the RFID test tag 22, which may be varied as to a certain type and distance from the radiator(s) and reader(s), “looks like” to the reading system 30 in different saturation areas of a given environment. Accordingly, “tuning” the disclosed system using tuner 34 needn't depend on expertise within the RF engineering field regarding where to place and how to configure RFID readers and antennas, as does the known art. Rather, in the disclosed system, the RF hardware is simply placed in the area according to broad guidelines, and the system may be trained or may self-train to recognize the desired patterns of tag movements.

More particularly, a system controller solution may be provided that employs machine learning within controller 32, and more particularly pattern recognition, to enable non-professional setup of the RFID reading system, and to enable a RFID reader solution for use in niche environments. That is, pattern recognition may be used to recognize a pattern in a given mapped saturation area, and to enforce a decision as to what is deemed a “correct” (or “incorrect”) read of a tag or tags in that mapped saturation area.

Thereafter, and based on this pattern recognition, a machine learning rules matrix stored in the disclosed processing system may verify and learn that each correct answer is, indeed, correct, and may modify the applied rules such that each answer indicated to the system as being “incorrect” upon first reading(s) should now be correctly read in subsequent readings. Accordingly, the system does not need to be taught proper outcomes for every conceivable tag, or for every conceivable place in which a tag may be read, in a given environment, nor does the system need to be retaught upon each change to the environment, such as due to the moving of clothing racks in a retail embodiment.

In an embodiment, a plurality of radiators, a plurality of readers and at least one controller may form one or more mesh networks that may be mapped in a given environment. Each network may represent a unique saturation and reading area within an environment, wherein each unique area may have its own matrix of tag-reading rules applicable thereto. Alternatively, an entire environment may form a single network, and areas in the network may be subjected to sub-rules, based on what portion of the map a tag read occurs within.

Accordingly, a user may be provided with a mobile device having, for example, an app 20 thereon, which is connectively associated with the described computing system at its back end, such as in the cloud. The user may then simply move about a mapped area, automatically or manually indicating to the controller what is happening in the area, and reviewing the decisions of the controller as to what reading is occurring as a test tag or tags 22, or an actual love tag 50, is moved through the area. Thereby, simplistic, noninvasive deployment of RFID reading systems is provided in a manner that is both inexpensive and easy to deploy by professional or nonprofessional setup personnel. That is, the embodiments may provide “plug and play” RFID reading systems, wherein non-professionals lay out equipment, and then use a mobile device to track the response of the equipment to tags in the environment until the system response is as desired.

As such, architecturally, the embodiments allow a mobile device to contain the interface to the local controller/software, and to communicate with the controller (which may provide machine learning services or other advanced and/or high volume processing), such as to guide a non-technical operator through training. This also enables a decoupling of logical functions, as discussed further herein below.

In accordance with the foregoing, the embodiments may provide an Internet of Things ready environment, such as a retail environment, in which microenvironments may be available or modifiable with minimal effort. That is, all aspects of an environment may be RFID tagged, and the environment may be saturated by RF radiators such that all aspects of the environment may be read/tracked at all times.

By way of example, in the prior art, a fitting room is very difficult to set up to read RFID tags of retail goods. Moreover, to the extent the fitting room is repainted or the mirrors modified after setup, known solutions would require a visit from a professional installation team to renew the environment. The foregoing is unnecessary in the disclosed inventive embodiments, because, although new paint or a mirror modification in the foregoing examples may provide for a renewed mapping, such a user walk through as using a mobile device having thereon an app in communication with the controller, upon the environmental renewal, no professional installation, reinstallation, or adjustment is needed.

The embodiments may allow for use in tracking every item in an entire store, or simply tracking items solely at read points, such as at exits, in fitting rooms, at receiving docks, at register or checkout locations, through warehouses, at distribution centers, or the like. Likewise, a system may service only particular areas of an environment, such as a high cost merchandise area in a retail environment, or may be used only in limited portions of a typical environment, such as allowing for mobile checkout from certain locations within a store by providing for the ability to read RFID tags at those location throughout the store, whereupon the tag reads may be communicated to a purchase system that interfaces with a mobile device of the user associated with purchasing the items associated with the tags.

Thus, the embodiments allow for elimination of RFID bottlenecks typical of the known art. Such bottlenecks historically occurred at exit points, but now, in the embodiments, all items within a store, by way of example, may become readable to the RFID system from anywhere in the store. Further, any modifications to the environment may be indicated to the system with minimal time and effort using the machine learning discussed herein.

As referenced throughout, a mobile device in the embodiments may provide for a self-healing, user configurable RFID reading environment that may be Internet of things enabled. The foregoing may be provided by a mobile device app and RFID hardware and tags that enable solutions for nearly any RFID reading environment, such as inventory solutions, small store solutions, big store solutions, airport solutions, or the like, using the same app and the same or similar commoditized hardware. The app disclosed may be programmable, by way of non-limiting example, using an API that provides suitable connections to the control system discussed throughout and to the user interface resident of the relevant app. Further, the proposed machine learning solution may treat each environment as a single environment or a series of microenvironments, and as such may necessitate no hardware or software multiplexing as occurs in the prior art.

Moreover, internal tag directional and status logic may thus be de-coupled from the controller interface to the host system. As such, while there are industry standard communication protocols/formats available, the embodiments require only a nominal effort to build a new communications module for connection to a different host system.

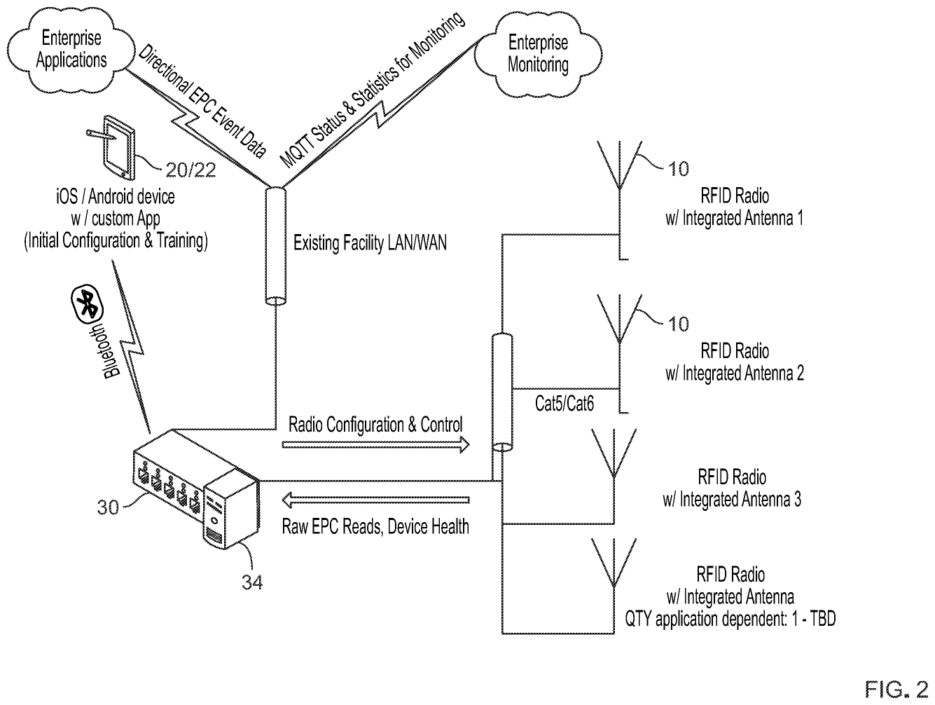

FIG. 2 illustrates an exemplary embodiment of a communications and power level schematic, such as for use in the disclosed system of FIG. 1. As illustrated, a plurality of RFID radios with integrated antennas may be provided to cover, substantially cover, or to pointedly cover a desired environment. These RFID radios may be of any type known to the skilled artisan in light of the discussion herein suitable for use in the embodiments, and may collectively communicate (such as over one or more communication buses in communicative association with each RFID radio), such as using Cat-5/Cat-6 cable, to enable two-way communication from the RFID radios to a command and control hub as discussed throughout.

In the two-way communications referenced above, inbound communications to each RFID radio may include radio configuration, tuning, and control, by way of nonlimiting example. Outgoing communication from each RFID radio may include electronic product code reads, device health, power level, operational alerts, and the like, by way of nonlimiting example.

The command and control hub may be any computing and/or server resource suitable to carry out the functionality described herein. As referenced above, the command and control hub may engage in two-way communication with each RFID radio in a monitored environment. That is, the hub may include an application package for the control of devices, the receipt of raw EPC data, the making of directional and tuning decisions, and the relaying of information and decisions to enterprise level applications (such as may include training decisions and processes), and with user interactive training processes (such as may be present on one or more mobile devices). Yet further, the hub may include power provision, such as through the use of power over Ethernet switching, to provide and monitor power to the RFID radio devices.

As indicated, the hub may communicate with one or more on-site mobile devices, such as may include custom applications for initial configuration and training, and for training modifications. Such mobile devices may include, by way of nonlimiting example, Apple and Android devices, and the communication to the hub may occur wirelessly in the preferred embodiments, such as using Bluetooth, Wi-Fi, infrared, proximity sensing, or the like. Accordingly, a user of the mobile device may communicate from the mobile device to the hub by the interconnectivity of the one or more applications on the mobile device and the correspondent one or more host applications on the hub, such as to engage in configuration, training, and monitoring of the disclosed systems.

The hub may further communicate with enterprise level applications as discussed throughout, such as may include machine learning applications, RFID directional control, EPC event data, status monitoring, statistical monitoring, interface to accounting and loss systems, and the like. The communication between the hub and enterprise level applications may occur, by way of nonlimiting example, via wired, such as Ethernet, or wireless, such as LAN/WAN, Bluetooth, or the like, and may employ any type of messaging system. By way of nonlimiting example, a lightweight messaging system between the hub and the enterprise level may be employed, such as MQTT by way of nonlimiting example.

The known art necessitates that, when an inventory system needs to integrate to a new read point or read point type, a development effort by RF engineers must occur. As referenced above, such a development effort may be substantial in length, such as on the order of multiple weeks, including various required testing.

On the contrary, the disclosed embodiments provide a modular interface layer to the RFID/EPC software stack. As such, multiple interfaces may be made available to the software stack to enable use of the event any of various type of mobile devices, hubs, and RFID readers. Moreover, directional modification events, such as changes in a retail environment, placement of walls or new clothing holders in a retail environment, or the like, may be predefined and readily selectable to the user in a mobile application. Upon selection by the user, the system may perform monitoring and learning to come up with a best fit for the environment, and as such, make the prior arts use of RF engineers unnecessary.

The known art also necessitates the design and tuning of RFID readers to a specific environment by an RF engineer. This directional pattern development is highly time-consuming, at least in that multiple steps, including multiple testing steps, are required to be performed by the RF engineer before a suitable environmental pattern is fitted.

On the contrary, the foregoing are not necessary in the disclosed embodiments. Contrary to the known art, an array of commodity RFID read points may be installed by non-experts in the disclosed embodiments. Once installed, nontechnical users use a mobile app and a plurality of RFID training software tags and correspondent hardware to set up and train a system. This training may occur by the user simply walking through the environment, while indicating to the disclosed system performance of certain directional and read events. The pattern recognition and self-learning in the disclosed embodiments may therefrom design and complete the required directional environment, and the foregoing steps may be easily repeated. In the event the environment is substantially modified.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A system for providing an after-market dynamic RFID reader network in a niche retail environment, comprising:
a plurality of RF transceivers located around the niche environment so as to saturate the niche environment with radio frequencies capable of ringing RFID tags brought within the niche environment;
an on-site controller capable of initially mapping a pattern provided by all of the plurality of RF transceivers in the niche environment;
a testing tag suitable to be moved through the mapped pattern, wherein the on-site controller tracks the ringing of the testing tag as it moves through the mapped pattern; and
an electronic tuner communicatively associated with the on-site controller, the electronic tuner being capable of tuning for the plurality of RF transceivers such that the RF transceivers indicate to the on-site controller a receipt of the ringing from the testing tag at all predetermined points in the mapped pattern.

2. The system of claim 1, wherein the tuning comprises machine learning.

3. The system of claim 1, wherein the machine learning comprises pattern recognitions.

4. The system of claim 1, wherein the tuning at least partially comprises manual user entries to an interface.

5. The system of claim 1, wherein the predetermined points include at least walking paths, clothing racks, and fitting rooms.

6. The system of claim 1, wherein each RF transceiver comprises an antenna.

7. The system of claim 1, wherein the tuning comprises a tuning of the on-site controller.

8. The system of claim 1, wherein the tuning comprises a signal modification to at least one of the RF transceivers.
